(19) United States
(12) Patent Application Publication
(10) Pub. No.: US 2024/0416515 A1
(43) Pub. Date: Dec. 19, 2024

(54) AUXILIARY FILE-GENERATING SIMULATION DEVICE AND CONTROL SYSTEM

(71) Applicant: Fanuc Corporation, Yamanashi (JP)

(72) Inventor: Tomoki Kato, Minamitsuru-gun, Yamanashi (JP)

(73) Assignee: Fanuc Corporation, Yamanashi (JP)

(21) Appl. No.: 18/702,433

(22) PCT Filed: Oct. 28, 2021
(86) PCT No.: PCT/JP2021/039885

§ 371 Date: Apr. 18, 2024

(51) Int. Cl. B25J 9/16

(52) U.S. Cl. CPC B25J 9/1658; B25J 9/1671

(57) ABSTRACT

A simulation device includes a simulation execution unit that performs a simulation based on a robot operation condition. The simulation device further includes: an operation information acquisition unit that acquires robot operation information based on results of the simulation; and an auxiliary file generation unit that generates, based on the robot operation information, a plurality of auxiliary files for generating a program written in a language that a programmable logic controller can read and execute.

### CROSS REFERENCE TO RELATED APPLICATIONS

This is the U.S. National Phase application of PCT/JP2021/039885, filed Oct. 28, 2021, the disclosure of this application being incorporated herein by reference in its entirety for all purposes.

### FIELD OF THE INVENTION

The present invention relates to a simulation device and a control system, for generating auxiliary files.

### BACKGROUND OF THE INVENTION

In a machine such as a machine tool and a robot device, a switch, a sensor or the like are arranged in order to control a drive machine such as a motor included in the machine. A programmable logic controller (PLC) is known as a device for setting the order in which a plurality of drive machines is caused to operate (e.g., Japanese Patent No. 6914452B). The PLC can control the order of operation, such as driving a drive machine, sending a signal, and receiving a signal from a sensor. The programmable logic controller is driven based on, for example, a PLC program called a ladder diagram described in a ladder language or the like.

On the other hand, a robot device with a robot and a work tool is controlled by a robot program described in the robot language. In recent years, a functionality of controlling the robot device by a PLC program has been known. For example, in the PLCopen (resistor trademark) standard for the purpose of improving the efficiency of PLC development, it is known that the position and orientation of the robot are controlled by a PLC program. This functionality allows an operator who is unfamiliar with the robot language to use the PLC program functionality and cause the robot to operate.

### PATENT LITERATURE

PTL 1: Japanese Patent No. 6914452B

### SUMMARY OF THE INVENTION

When generating a robot program for driving a robot device, it may be difficult to determine an optimal operation path in the work of driving an actual robot device. It is known that a simulation device that simulates a robot operation is used in generating a robot operation path. The simulation device can also generate a robot program based on the operation path of the robot generated by the simulation. However, the simulation device in the prior art outputs a robot program described in the robot language. For this reason, even an operator familiar with a PLC program has to learn the robot program described in the robot language.

A first aspect of the present disclosure is a simulation device that includes a simulation executing unit configured to perform a simulation of operation of a robot, based on an operation condition of the robot. The simulation device includes an operation information acquisition unit configured to acquire operation information of the robot, based on a result of the simulation by the simulation executing unit. The simulation device includes an auxiliary file generating unit configured to generate a plurality of auxiliary files for generating a program described in a language that can be read by a programmable logic controller so as to execute the program, based on the operation information of the robot.

A second aspect of the present disclosure is a control system that includes the simulation device and the programmable logic controller. The programmable logic controller includes a program generating unit configured to generate a program described in a language for driving the programmable logic controller, based on the plurality of auxiliary files.

The aspects of the present disclosure allow to provide a simulation device that generates a plurality of auxiliary files for generating a PLC program, and a control system including the simulation device.

### BRIEF DESCRIPTION OF DRAWINGS

FIG. 1 is a schematic diagram of a robot device according to an embodiment.

FIG. 2 is a block diagram of a control system according to an embodiment.

FIG. 3 is a block diagram of a simulation device according to an embodiment.

FIG. 4 is an image displayed at a display part of a simulation device.

FIG. 5 is a program file generated by a simulation device.

FIG. 6 is a variable file generated by a simulation device.

FIG. 7 is a first FB file generated by a simulation device.

FIG. 8 is a second FB file generated by a simulation device.

FIG. 9 is a third FB file generated by a simulation device.

FIG. 10 is a block diagram of a PLC according to an embodiment.

FIG. 11 is a PLC program generated by a PLC.

FIG. 12 is a block diagram of a robot controller according to an embodiment.

### DETAILED DESCRIPTION OF EMBODIMENTS OF THE INVENTION

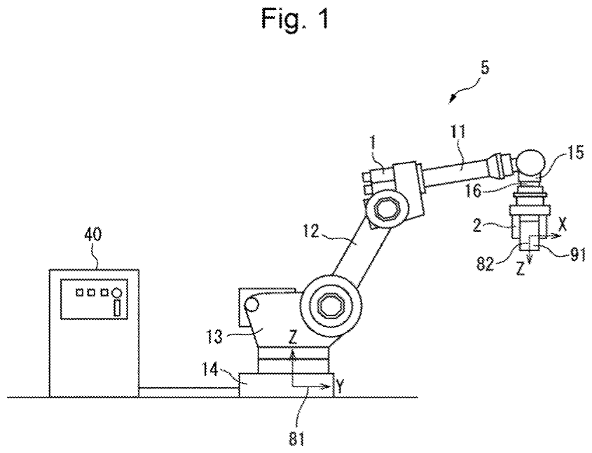

Referring to FIG. 1 to FIG. 12, a simulation device and a control system including the simulation device, according to an embodiment will be described. The simulation device of the present embodiment generates a plurality of auxiliary files for generating a PLC program that causes a programmable logic controller (hereinafter referred to as “PLC”) to operate. The control system generates a PLC program by using the plurality of auxiliary files.

FIG. 1 is a schematic diagram of a robot device that performs simulation by a simulation device according to the present embodiment. A robot device 5 of the present embodiment performs the work of carrying a workpiece 91. The robot device 5 includes a hand 2 serving as a work tool and a robot 1 for moving the hand 2. The robot device 5 includes a robot controller 40 for controlling the robot 1 and the hand 2.

The robot 1 of the present embodiment is an articulated robot including a plurality of joints. The robot 1 of the present embodiment includes a base 14 and a turning base 13 rotated with respect to the base 14. The robot 1 includes an upper arm 11 and a lower arm 12. The lower arm 12 is rotatably supported by the turning base 13. The upper arm 11 is rotatably supported by the lower arm 12. The robot 1 includes a wrist 15 rotatably supported by the upper arm 11. The hand 2 is fixed to a flange 16 of the wrist 15. In addition, the upper arm 11 and the flange 16 rotate around a predetermined drive axis.

The robot of the present embodiment includes six drive axes, but the embodiment is not limited to this. A robot that changes the position and orientation by any mechanism can be employed. The work tool of the present embodiment is a hand including two claw parts, but the embodiment is not limited to this. As the work tool, any device according to the operation performed by the robot device may be employed.

A robot coordinate system 81 is set at the robot device 5 of the present embodiment. The robot coordinate system 81 is also referred to as the world coordinate system. The robot coordinate system 81 is a coordinate system in which the position of the origin is fixed and the directions of the coordinate axes are fixed. Even when the robot 1 is driven, the position of the origin and direction of the robot coordinate system 81 do not change.

Further, the robot device 5 is configured with a tool coordinate system 82 having an origin set at any position of the work tool. In the present embodiment, the origin of the tool coordinate system 82 is set at the tool center point. The tool coordinate system changes the position and orientation with the work tool. The position of the robot 1 corresponds to the position of the origin of the tool coordinate system 82 in the robot coordinate system 81. The orientation of the robot 1 corresponds to the direction of the tool coordinate system 82 with respect to the robot coordinate system 81.

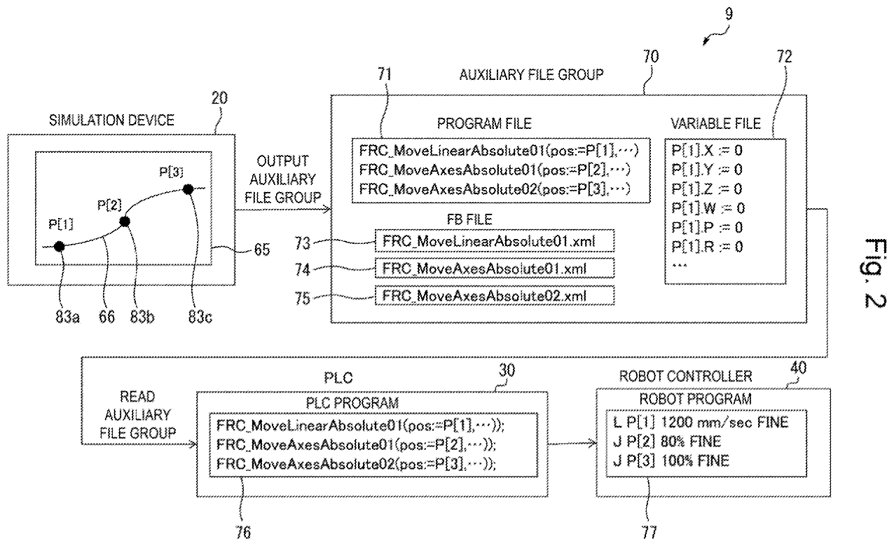

FIG. 2 illustrates a schematic diagram of a control system for controlling the robot of the present embodiment. A control system 9 of the present embodiment includes a simulation device 20 for performing a simulation of the operation of the robot device 5, a PLC 30, and the robot controller 40 of the robot device 5.

In the present embodiment, among various operations of the robot, an operation and a program in which the tool center point (a point corresponding to the position of the robot) passes through three teaching points, will be taken up as an example and described. For various other operations of the robot, the PLC program can be created and the robot can be controlled by the same control as in the present embodiment.

The simulation device 20 performs a simulation of the operation of the robot device 5. FIG. 2 illustrates an image 65 displayed at the display part of the simulation device 20. The image 65 illustrates an operation path 66 of the robot 1 generated by the simulation device 20. The simulation device 20 generates the operation path 66 of the robot 1 based on the operation conditions such as the positions of a plurality of teaching points 83a, 83b, and 83c.

The simulation device 20 of the present embodiment generates an auxiliary file group 70 based on the result of the simulation including the operation path 66 of the robot 1. The auxiliary file group 70 includes a plurality of auxiliary files for generating a PLC program 76. The plurality of auxiliary files include a program file 71 in which a function representing the operation of the robot 1 is described, and a variable file 72 in which a definition of variable used in the PLC program 76 is described. Further, the plurality of auxiliary files include function block files 73 to 75 in which the contents of the operation of the robot (definition of the operation command) corresponding to the function for representing the operation of the robot described in the program file 71 are described. In the present embodiment, the function block file is called FB file.

The PLC 30 acquires the auxiliary file group 70. The PLC 30 generates the PLC program 76 as a program described in the language that drives the PLC, based on the auxiliary file. The PLC program is described in a language that can be read by the PLC so as to execute the program. The PLC program 76 of the present embodiment is described in the structured text (ST) language among languages readable by the PLC 30.

The PLC 30 of the present embodiment can perform control of driving the robot device 5 for each function FRC corresponding to one command statement described in the PLC program 76. The PLC 30 executes the PLC program 76 together with the FB files 73 to 75 and transmits a control signal related to the command statement included in the PLC program 76 to the robot controller 40. The robot controller 40 generates a command statement described in the robot language in order to drive the robot device 5 based on the control signal from the PLC 30. The robot controller 40 can drive a robot device based on a command statement in the robot language.

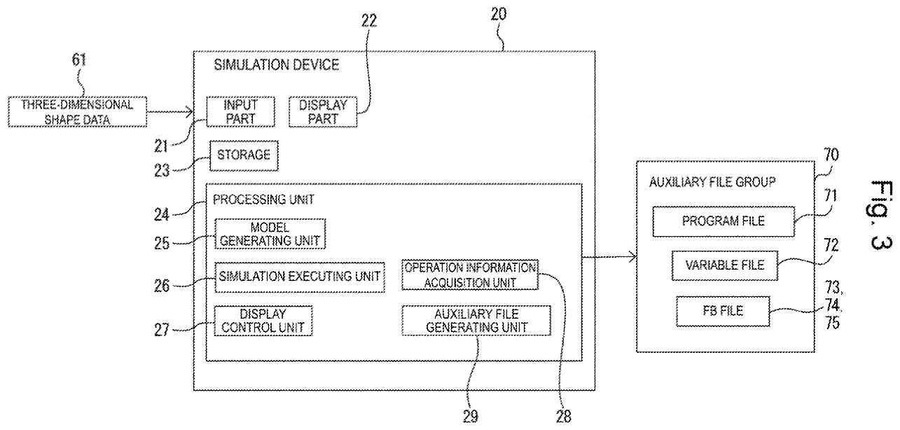

FIG. 3 illustrates a block diagram of the simulation device according to the present embodiment. The simulation device 20 of the present embodiment is an offline simulation device formed so as to simulate the operation of the robot device 5. In the simulation device 20 of the present embodiment, a three-dimensional model of the robot 1, a three-dimensional model of the hand 2, and a three-dimensional model of the workpiece 91 are arranged in the same virtual space, and a simulation of the operation of the robot device 5 is performed.

The simulation device 20 includes an arithmetic processing device (computer) including a central processing unit (CPU) as a processor. The arithmetic processing device of the present embodiment is composed of a personal computer. The arithmetic processing device includes a random access memory (RAM) and a read only memory (ROM) connected to the CPU via a bus.

The simulation device 20 includes a storage 23 for storing any information about the simulation of the robot device 5. The storage 23 may be composed of a non-transitory storage medium capable of storing information. For example, the storage 23 may be composed of a storage medium such as a volatile memory, a nonvolatile memory, a magnetic storage medium, or an optical storage medium. The program for performing the simulation of the robot device is stored at the storage 23.

Three-dimensional shape data 61 of the robot 1, the hand 2, and the workpiece 91 are input to the simulation device 20. The three-dimensional shape data 61 includes data of the robot, the work tool, peripheral devices and the workpiece, for simulating the robot device 5. Data output from a computer aided design (CAD) device, for example, can be used as the three-dimensional shape data 61. The three-dimensional shape data 61 are stored at the storage 23.

The simulation device 20 includes an input part 21 for inputting information about the simulation of the robot device 5. The input part 21 is composed of an operation member such as a keyboard, a mouse, and a dial. The simulation device 20 includes a display part 22 that displays information about the simulation of the robot device 5. The display part 22 displays the image of a model of the robot device 5 and the image of a model of the workpiece 91. The display part 22 is composed of a display panel such as a liquid crystal display panel. When the simulation device includes a touch panel display panel, the display panel functions as an input part and a display part.

The simulation device 20 includes a processing unit 24 that performs arithmetic processing for the simulation of the robot device 5. The processing unit 24 includes a model generating unit 25 that generates a model of the member based on the three-dimensional shape data 61. For example, the model generating unit 25 generates a robot device model as a model for a robot device, and a workpiece model as a model for a workpiece.

The processing unit 24 includes a simulation executing unit 26 for performing a simulation of the operation of the robot device 5. The simulation executing unit 26 has a functionality of moving the robot device model at the screen in response to the operation of the input part 21 by the operator. Alternatively, the simulation executing unit 26 performs the simulation of the operation of the robot based on the predetermined operation conditions of the robot.

For example, the simulation executing unit 26 performs a simulation of the operation of the robot device 5 based on previously generated teaching points. The operator sets a position of the teaching point, an orientation of the robot at the teaching point, a linear motion or a curved motion, a driving speed of the robot, or the like, by the operation of the input part 21. In addition, the operator can set whether the tool center point passes through the teaching point or smooth driving is performed so that the tool center point passes through the vicinity of the teaching point. The simulation executing unit 26 performs a simulation in which the robot model is driven so that the tool center point of the robot model is moved by a movement method specified by the operator.

The processing unit 24 includes an operation information acquisition unit 28 for acquiring operation information of the robot 1 based on the simulation of the operation of the robot device 5. The operation information acquisition unit 28 can acquire operation conditions such as the operation path when the robot is driven and the operating speed of the robot as operation information of the robot 1.

The processing unit 24 includes an auxiliary file generating unit 29 that generates the auxiliary file group 70 based on the operation information of the robot 1 acquired by the operation information acquisition unit 28. The auxiliary file group 70 includes a plurality of auxiliary files for generating a PLC program that drives the PLC. Each auxiliary file is formed in a language and rules readable by the PLC. The auxiliary file generating unit 29 in the present embodiment generates the program file 71, the variable file 72, and the FB files 73 to 75.

The processing unit 24 includes a display control unit 27 that controls the image displayed at the display part 22. The display control unit 27 changes the position and orientation of the robot model in response to the operation of the input part 21 by the operator. The display control unit 27 can display, at the display part 22, the operation path of the robot when the robot device is driven.

The processing unit 24 corresponds to a processor driven based on a simulation program (software). The program of the simulation is previously created and stored at the storage 23. The processor functions as the processing unit 24 by implementing the control defined in the program of the simulation. Furthermore, the model generating unit 25, the simulation executing unit 26, the display control unit 27, the operation information acquisition unit 28, and the auxiliary file generating unit 29 correspond to processors driven based on the program of the simulation. The processors perform the controls defined in the program, thereby functioning as respective units.

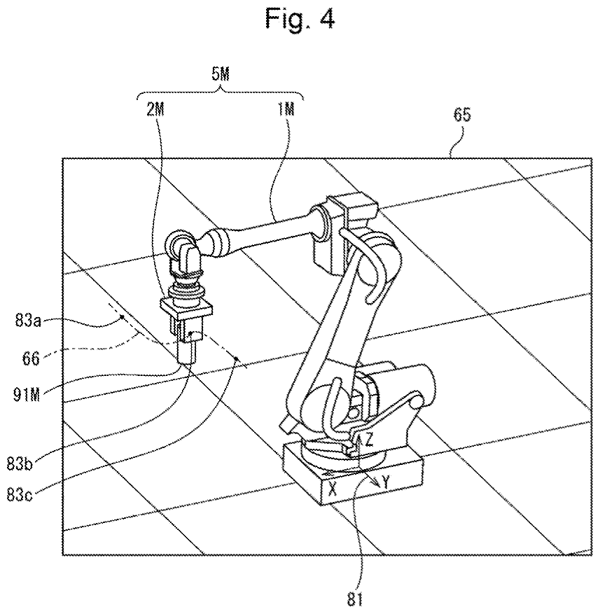

FIG. 4 illustrates an example of an image displayed at the display part of the simulation device. The image 65 illustrates the state when the simulation of the robot device 5 is performed. Referring to FIG. 3 and FIG. 4, the model generating unit 25 generates a robot device model 5M. The model generating unit 25 generates a robot model 1M and a hand model 2M based on the three-dimensional shape data 61. The model generating unit 25 generates a workpiece model 91M based on the three-dimensional shape data 61. The model generating unit 25 may display a model of a peripheral device arranged around the robot based on the three-dimensional shape data 61.

The display control unit 27 displays an image of the robot model 1M, an image of the hand model 2M, and an image of the workpiece model 91M. In the present embodiment, the display control unit 27 displays a three-dimensional image, but may display a two-dimensional image. The model generating unit 25 can set the robot coordinate system 81 set at the actual robot device 5 in a virtual space in which the robot device model 5M and the workpiece model 91M are arranged. As with the actual robot device 5, the position and orientation of the robot can be specified in the simulation by using the robot coordinate system 81.

The simulation executing unit 26 changes the position and orientation of the robot model 1M in the image 65 in response to the operation of the input part 21. The operator specifies, for example, the teaching points 83a, 83b, and 83c. In this case, the simulation executing unit 26 performs the simulation of the robot 1 so that the tool center point passes through the teaching points 83a, 83b, and 83c according to the input of the operation condition by the operator. The simulation executing unit 26 can calculate the operation path 66, which is the trajectory through which the tool center point passes, based on the result of the simulation. The display control unit 27 can display the operation path 66 overlapped with the images of the robot device model 5M and the workpiece model 91M.

The operator activates the robot device model 5M at the screen and checks the operation status of the robot device. When the result of the simulation is not favorable, the operator can modify the operation conditions of the robot such as the position of the teaching point and the orientation of the robot at the teaching point. When it is confirmed that the robot device model 5M is driven in the desired state, the operator can determine the operation of the robot device. The operation information acquisition unit 28 can acquire the operation information of the robot including the operation path of the robot. The operation information acquisition unit 28 can acquire the position of the teaching point when the robot is driven, the orientation of the robot at the teaching point, the operation path, or the like, in the coordinate values of the robot coordinate system 81. The operation information acquisition unit 28 can acquire operation conditions such as the operating speed of the robot.

The auxiliary file generating unit 29 of the processing unit 24 generates the auxiliary file group 70 based on the operation information of the robot device 5 acquired by the operation information acquisition unit 28. Next, the program file 71, the variable file 72, and the FB files 73 to 75 included in the auxiliary file group 70 will be described. The respective files of the program file 71, the variable file 72, and the FB files 73 to 75 in the present embodiment are configured in the format of xml file. These auxiliary files can be generated in the format of xml file (xml format) defined by, for example, the PLCopen standard, or the like.

For example, the fixed form sentence (template) of the xml file described at the beginning portion and the end portion of the auxiliary file may employ a template defined by the PLCopen standard or the like. The template includes a declaration that the language is for running robots on PLC, or the like.

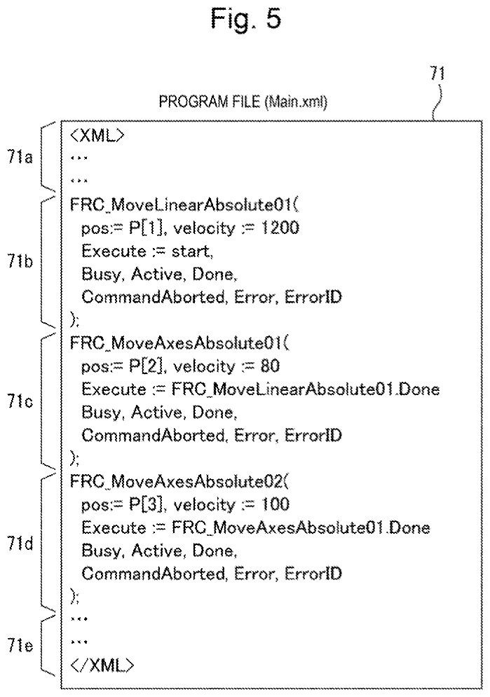

FIG. 5 illustrates an example of a program file generated by an auxiliary file generating unit. A file name of the program file of the present embodiment is “Main.xml”. In the program file 71, a command statement for the operation of the robot device 5 is described in the form of function. In this case, the first teaching point 83a is represented by a symbol P [1], the second teaching point 83b is represented by a symbol P [2], and the third teaching point 83c is represented by a symbol P [3].

In the program file 71, the main processing in the PLC program is described. The program file 71 is composed of a plurality of regions 71a to 71e. The region 71a, at the beginning of the program file 71, describes the fixed form sentence (template) of the xml file. In addition, the region 71e, at the end of the program file 71, describes the fixed form sentence (template) of the xml file. The descriptions other than the templates in the regions 71a and 71e are employed in the PLC program.

At the regions 71b to 71d, a function that serves as a command statement in the PLC program is described. Depending on each robot operation, a function starting with FRC is described. The region 71b describes the operation in which the robot device is activated and the tool center point is driven to the first teaching point 83a. The first line of the region 71b describes a function FRC_MoveLinearAbsolute01. The name of this function corresponds to the file name of the function block to be quoted.

In the operation of the function FRC_MoveLinearAbsolute01, the tool center point at which the robot is positioned moves to a position P [1] represented by a variable pos. The tool center point moves linearly at a speed of 1200 mm/sec represented by a variable velocity. In this case, positioning is performed so as to pass through the position P [1]. A variable Execute represents a start time of this function. In this case, the start of driving of the robot is represented. Subsequently, variables are defined for representing the execution state such as a variable busy, a variable Active, a variable Done.

Like the region 71b, the region 71c describes a function for driving the robot. The region 71c describes the operation in which the tool center point is driven from the first teaching point 83a to the second teaching point 83b. At the region 71c, the first line describes a function FRC_MoveAxesAbsolute01. In this function, it is described that the tool center point moves by driving each axis (by moving in a curved shape) at a speed that is 80% of the maximum speed up to a position P [2]. The description of the variable Execute represents that this function is performed after the end of the operation of the function FRC_MoveLinearAbsolute01 at the region 71b.

At the region 71d, as at the region 71c, the function for driving the robot is described. A function FRC_MoveAxesAbsolute02 represents that the tool center point moves to a position P [3] after the end of the robot operation by the function FRC_MoveAxesAbsolute01 at the region 71c. It is represented that the robot moves the tool center point by driving each axis at 100% speed with respect to the maximum speed.

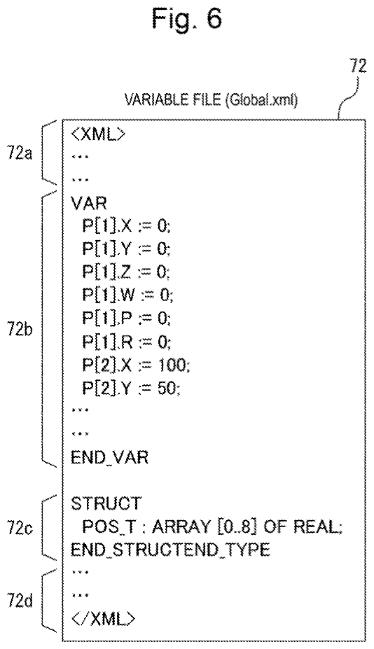

FIG. 6 illustrates an example of a variable file generated by the auxiliary file generating unit. The variable file 72 defines the global variable, the structure, and the like, which are used in the PLC program. The file name of the variable file 72 is “Global.xml”. The variable file 72 is composed of a plurality of regions 72a to 72d. At the regions 72a and 72d, fixed form sentences (templates) of xml file are described.

The region illustrated in a variable VAR at the region 72b defines global variables. In this case, the position and orientation of the robot at the position P [1] representing the first teaching point are defined in the coordinate values of each coordinate axis of the robot coordinate system 81. Following the position P [1], the position and orientation of the robot at the position P [2] of the second teaching point 83b and at the position P [3] of the third teaching point 83c are determined. The region specified by a variable STRUCT at the region 72c describes the structure definition. In this case, it is determined that the variable of the structure is a value of the real type and is composed of an array from 0 to 8. It is preferable that such variable VAR and variable STRUCT use a predetermined variable by a standard or the like. Further, the variable defined in the variable file is not limited to the above form, and any variable for driving the robot can be employed.

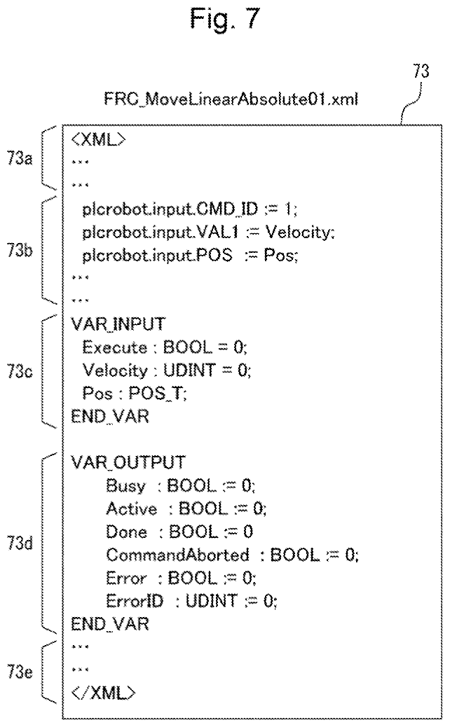

FIG. 7 illustrates a first FB file generated by the auxiliary file generating unit. The first FB file 73 is quoted in the function described in order to move the position of the robot to the first teaching point. The first FB file 73 is quoted when the function FRC_MoveLinearAbsolute01 described at the region 71b of the program file 71 illustrated in FIG. 5 is executed. The file name of the first FB file 73 is defined in “FRC_MoveLinearAbsolute01.xml” corresponding to the name of the function described in the program file 71. The FB file defines the operation of the robot in the function used in the PLC program, and the processing of the function block.

The first FB file 73 includes a plurality of regions 73a to 73e. The region 73a at the beginning portion of the file and the region 73e at the end portion of the file describe fixed form sentences of xml file.

At the region 73b, the processing is described by variables of the structure. A variable plcrobot.input.CMD_ID at the first line of the region 73b represents a method of operating the robot. When this variable is 1, it is specified that the robot is linearly driven and the motion is positioning. When this variable is 2, it is specified that the robot is driven by each axial motion and the motion is positioning. It should be noted that another variable may be assigned to whether the motion of the robot is a positioning motion through the teaching point or a smooth motion that suffices if the vicinity of the teaching point is passed.

A variable plcrobot.input. VALI quotes the operating speed (1200 mm/sec) specified in the function FRC_MoveLinearAbsolute01 at the region 71b of the program file 71. By a variable plcrobot.input. POS, the target position is specified by quoting the position P [1] defined in the above function of the program file 71.

The region 73c represents the input variable to the function block. The definition of the input variables is defined at the region from a variable VAR_INPUT to a variable END_VAR. In this example, the variable Execute, which represents the start of control, is a Boolean with an initial value set to 0. Additionally, a velocity variable Velocity is an unsigned double-precision integer with an initial value set to 0. The variable POS_T is employed as the position variable Pos.

At the region 73d, the output variable of the function block is defined. The output variables are defined at the region from a variable VAR_OUTPUT to the variable END_VAR. A variable Busy represents that the operation is in progress and is a Boolean variable. The variable Active represents that control is in progress. The variable Done represents that the operation is ended. A variable CommandAborted represents that the operation is interrupted in the middle. A variable Error represents that an abnormality occurs. A variable ErrorID represents the code corresponding to the content of the abnormality. The initial value of each variable is set to 0.

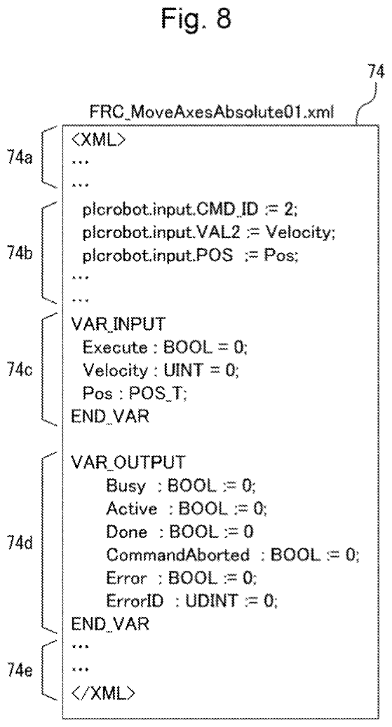

FIG. 8 illustrates a second FB file generated by the auxiliary file generating unit. The second FB file 74 is quoted when the function FRC_MoveAxesAbsolute01 described at the region 71c of the program file 71 illustrated in FIG. 5 is executed. The second FB file 74 has the same structure as the first FB file 73. At regions 74a and 74e, the fixed form sentence of xml file is described. At a region 74b, variables of the structure are defined. Input variables are defined at a region 74c, and output variables are defined at a region 74d.

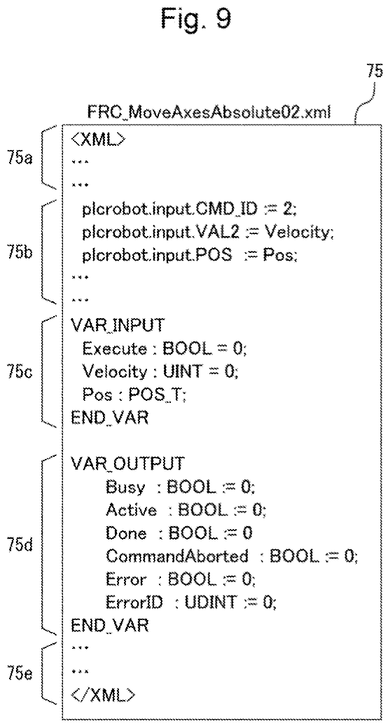

FIG. 9 illustrates a third FB file generated by the auxiliary file generating unit. The third FB file 75 is quoted when the function FRC_MoveAxesAbsolute02 described at the region 71d of the program file 71 illustrated in FIG. 5 is executed. The third FB file 75 has the same structure as the first FB file 73. At regions 75a and 75e, the fixed form sentences of xml file are described. At a region 75b, variables of the structure are defined. Input variables are defined at a region 75c, and output variables are defined at a region 75d.

Thus, the FB file illustrates the functionality corresponding to the function described in the program file. In the FB file, commands for performing specific controls are described. It should be noted that the FB file may not be an auxiliary file generated in a format in which the contents can be visually recognized by the operator. In other words, the FB file may be generated in a format that cannot be read by the operator.

Referring to FIG. 3, the auxiliary file generating unit 29 can generate respective auxiliary files based on the execution result of the simulation. The auxiliary file generating unit 29 generates auxiliary files in a format that can be read by the PLC. In the present embodiment, each auxiliary file is described in the ST language.

The language for generating a PLC program is not limited to the ST language. The auxiliary file generating unit may use any language that can be read by the PLC. For example, a PLC program using the ladder diagram (LD) language can be generated as a programming language. In addition to the LD language, the instruction list (IL) language, the sequential function chart (SFC) language, or the function block diagram (FBD) language can be employed as the programming language. Alternatively, auxiliary files may be generated by combining these plurality of languages.

The respective functions and variables included in the auxiliary files may be predetermined. For example, the functions and variables in the auxiliary file may use the functions and variables defined in the PLCopen standard. The auxiliary file generating unit 29 may input the value of variable into the template of the previously created auxiliary file. For example, in the variable file 72 illustrated in FIG. 6, a template of the variable of the region 72b can be generated. The auxiliary file generating unit 29 may generate a variable file by inputting the value of the variable based on the result of the simulation.

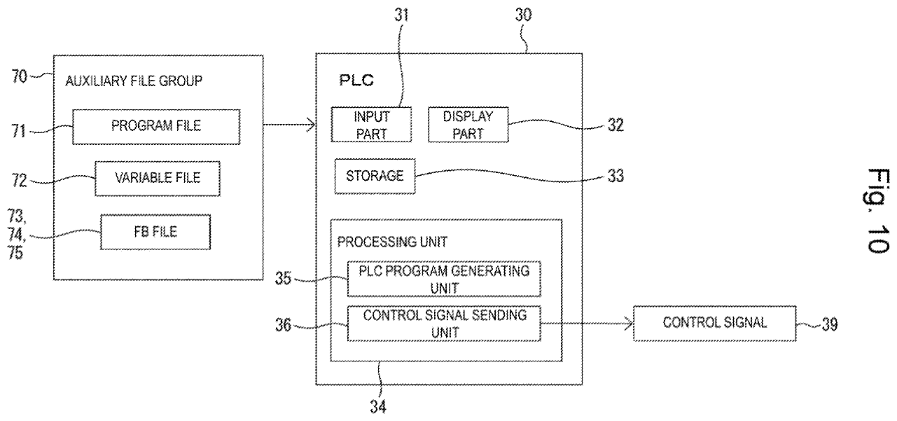

FIG. 10 illustrates a block diagram of a PLC according to the present embodiment. The PLC 30 is composed of an arithmetic processing device (computer) including a CPU as a processor. The PLC 30 includes an input part 31, a display part 32, and a storage 33, same as the simulation device 20. The input part 31 is composed of an operation member such as a keyboard, a mouse, and a dial. The display part 32 is composed of a display panel such as a liquid crystal display panel. The storage 33 may be composed of a non-transitory storage medium capable of storing information.

The PLC 30 includes a processing unit 34. The processing unit 34 includes a PLC program generating unit 35 that generates the PLC program 76 based on the auxiliary file. The processing unit 34 includes a control signal sending unit 36 that sends a control signal 39 about driving the robot device 5 to the robot controller 40 based on the PLC program 76. The processing unit 34, the PLC program generating unit 35, and the control signal sending unit 36 correspond to processors driven according to a program (software) for driving the PLC.

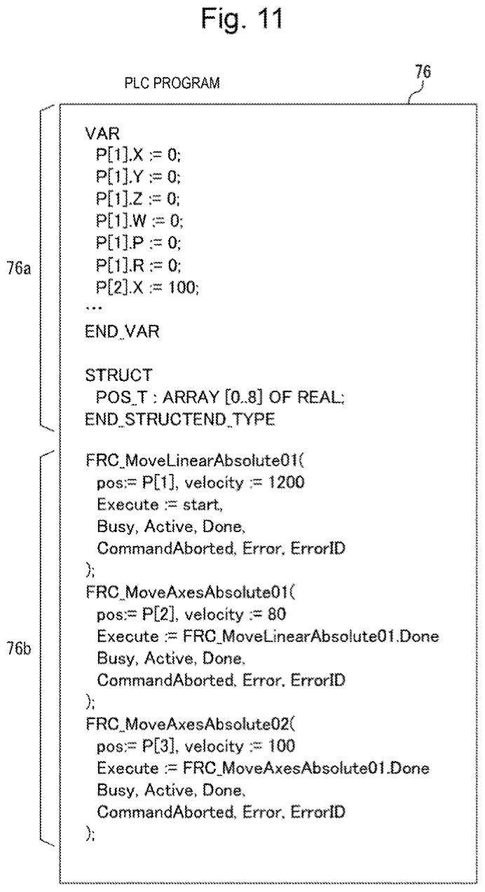

FIG. 11 illustrates a PLC program according to the present embodiment. The PLC program generating unit 35 reads the auxiliary file group 70 and generates the PLC program 76. The PLC program 76 includes, for example, a region 76a and a region 76b. At the region 76a, the variables described in the variable file 72 are described (see FIG. 6). Then, at the region 76b following the region 76a, the functions described in the program file 71 are described (see FIG. 5). Thus, the PLC program generating unit 35 can generate the PLC program 76 by combining the program file 71 and the variable file 72. The PLC program 76 is created in any format that can be read and executed by the PLC 30. The PLC program 76 of the present embodiment is not created in xml format, but is formed in the ST language.

The PLC 30 is driven based on the PLC program 76 generated by the PLC program generating unit 35, and the FB files 73 to 75. The control signal sending unit 36 transmits a control signal for driving the robot device 5 to the robot controller 40 for each function FRC as a command statement described in the PLC program 76.

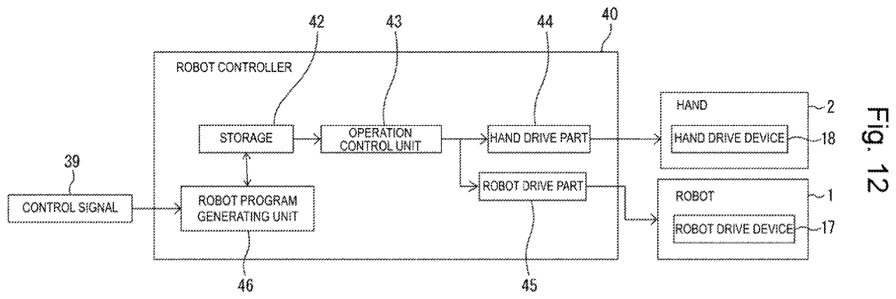

FIG. 12 illustrates a block diagram of the robot device 5 according to the present embodiment. Referring to FIG. 1 and FIG. 12, the robot 1 includes a robot drive device 17 including a drive motor for changing the position and orientation of the robot 1. The robot device 5 includes a hand drive device 18 for driving the hand 2. The hand drive device 18 includes a cylinder for driving a claw part of the hand 2, an air pump, or the like.

The robot controller 40 includes an arithmetic processing device (computer) including a CPU as a processor. The robot controller 40 includes an operation control unit 43 that generates operation commands for the robot 1 and the hand 2. The operation control unit 43 sends an operation command for driving the robot 1 to a robot drive part 45. The robot drive part 45 includes an electrical circuit that drives the robot drive device 17. The operation control unit 43 sends an operation command for driving the hand 2 to a hand drive part 44. The hand drive part 44 includes an electrical circuit that drives the hand drive device 18. The robot controller 40 includes a robot program generating unit 46 that generates a command statement of the robot program based on a control signal from the PLC 30. The robot program generating unit 46 generates a command statement of a robot program 77 in the robot language based on the control signal 39 about the PLC program 76 and the FB files 73 to 75.

The operation control unit 43 and the robot program generating unit 46 correspond to processors that are driven according to the program for controlling the robot device. The processors perform the control defined in the program, thereby functioning as the operation control unit 43 and the robot program generating unit 46.

The robot controller 40 includes a storage 42 for storing information about the control of the robot 1 and the hand 2. The storage 42 may be composed of a non-transitory storage medium capable of storing information. For example, the storage 42 may be composed of a storage medium such as a volatile memory, a nonvolatile memory, a magnetic storage medium, or an optical storage medium.

Referring to FIG. 2 and FIG. 12, the operation control unit 43 of the present embodiment generates operation commands for the robot 1 and the hand 2 based on the command statement described in the robot program 77 for causing the robot to operate. The robot program is described in the robot language. In this example, a robot program is illustrated for a robot that is driven so as to pass through the position P [1], the position P [2], and the position P [3] of three teaching points.

In the command statement of the first line, a symbol L represents a command in which the position of the robot moves linearly. The symbol P [1] represents the position of the teaching point, and the orientation of the robot at the teaching point. It is represented that a moving speed of the position of the robot (tool center point) is 1200 mm/sec. A symbol FINE represents that the robot is driven so as to pass through the teaching point.

In the command statement of the second line and the command statement of the third line, a symbol J represents a command for moving the position of the robot in a curved shape by driving a plurality of driving shafts of the robot 1. It is also represented that each drive axis is driven at a speed of 80% or 100% with respect to the maximum speed of each drive axis.

Referring to FIG. 10, FIG. 11, and FIG. 12, the control signal sending unit 36 of the PLC 30 of the present embodiment transmits the control signal 39 to the robot controller 40 every time one operation of the robot 1 is performed. The control signal sending unit 36 sends the control signal 39 related to the operation of the robot device every time the function FRC described at the region 76b of the PLC program 76 is executed. The robot program generating unit 46 generates a command statement in the robot language every time receiving the control signal 39 for performing the operation of the robot 1.

For example, the PLC 30 executes the PLC program 76 in order to drive the robot device 5. The data of the variable plcrobot.input. defined in the FB file is used as a parameter relating to the operation of the robot. When a value is input to the variable plcrobot.input., the control signal sending unit 36 transmits the data of the variable plcrobot.input. to the robot program generating unit 46 of the robot controller 40. The robot program generating unit 46 generates a command statement generated in the robot language based on the data of the variable plcrobot.input.

Referring to FIG. 7, in an operation in which the position of the robot moves to the first teaching point 83a, the robot program generating unit 46 acquires a control signal whose variable plcrobot.input.CMD_ID is 1. The robot program generating unit 46 determines that the motion of the robot is a linear motion and a positioning motion. The robot program generating unit 46 acquires the operating speed by the control signal about the variable plcrobot.input. VALI and acquires the target position by the control signal about the variable plcrobot.input.POS. The robot program generating unit 46 generates the command statement of the first line of the robot program 77 illustrated in FIG. 2 based on the data of these variables. The operation control unit 43 of the robot controller 40 reads the generated command statement and controls the robot 1.

In the control system 9 of the present embodiment, the simulation device 20 can output the auxiliary file group 70 for generating the PLC program 76. The functions and variables used in the PLC program 76, which are included in the auxiliary file, include commands of the control for causing the robot 1 to operate. The simulation device 20 can output auxiliary files described in the language used by the PLC program 76.

Thus, an operator using the PLC 30 can import the auxiliary file group 70 output from the simulation device 20 into the PLC 30 without converting the auxiliary file group 70 into the format of the PLC program 76. Then, the robot device 5 can be driven by generating the PLC program 76 at the PLC 30. Further, in the PLC 30, the auxiliary files such as the program file 71 and the FB files 73 to 75, or the PLC program 76 generated by the PLC program generating unit 35 can be modified. The operator can modify the program that drives the robot device 5 by using the language used in the PLC 30. Thus, the operator does not need to create the robot program 77 described in the robot language, and can operate the robot device 5 in the PLC program 76 without being familiar with the robot language.

In the present embodiment, the robot controller 40 generates a command statement of the robot program 77 based on the control signal 39 from the PLC 30, but the embodiment is not limited to this. The operation control unit 43 of the robot controller 40 may directly generate an operation command for causing the robot 1 to operate, based on the control signal 39 from the PLC 30. In other words, the robot controller 40 may generate an operation command without generating a command statement of the robot program 77.

In the present embodiment, the control signal 39 is sent to the robot controller 40 every time the PLC 30 executes a command statement for one operation of the robot, but the embodiment is not limited to this. The robot program generating unit 46 of the robot controller 40 may generate the robot program 77 including a plurality of command statements after acquiring the FB files 73 to 75 generated by the simulation device 20 and the PLC program 76 generated by the PLC 30. The robot controller 40 stores the acquired PLC program 76 at the storage 42. The robot controller 40 stores, at a predetermined storage region, the FB files 73 to 75 generated by the simulation device 20.

Next, the robot program generating unit 46 may generate the robot program 77 based on the PLC program 76 and the FB files 73 to 75. The robot program generating unit 46 converts the command statement described in the ST language of the PLC program 76 into the command statement of the robot language of the robot program 77. The robot program generating unit 46 can generate the robot program 77 including a plurality of command statements. The robot program 77 is stored at the storage 42. The operation control unit 43 can control the robot 1 and the hand 2 based on the robot program 77 generated by the robot program generating unit 46.

In each of the above controls, the sequence of steps can be changed as appropriate to the extent that the functionality and action are not changed.

The PLC program generating unit for generating the PLC program of the present embodiment is arranged at the PLC, but the embodiment is not limited to this. The PLC program generating unit may be arranged at the simulation device. In other words, the simulation device may generate the PLC program based on the auxiliary file group.

The above embodiments may be combined as appropriate. In the above respective drawings, the same or equivalent portions are denoted by the same reference signs. It should be noted that the above embodiments are examples and do not limit the invention. The embodiments also include modifications of the embodiments illustrated in the claims.

### REFERENCE SIGNS LIST

1 Robot
5 Robot device
9 Control system
20 Simulation device
24 Processing unit
26 Simulation executing unit
28 Operation information acquisition unit
29 Auxiliary file generating unit
30 PLC
35 PLC program generating unit
70 Auxiliary file group
71 Program file
72 Variable file
73, 74, 75 FB file
76 PLC program

1. A simulation device, comprising:
a simulation executing unit configured to perform a simulation of operation of a robot, based on an operation condition of the robot;
an operation information acquisition unit configured to acquire operation information of the robot, based on a result of the simulation by the simulation executing unit; and
an auxiliary file generating unit configured to generate a plurality of auxiliary files for generating a program described in a language that can be read by a programmable logic controller so as to execute the program, based on the operation information of the robot.

2. The simulation device of claim 1, wherein the plurality of auxiliary files include a program file in which a function representing the operation of the robot is described, a variable file in which a definition of a variable is described, and a function block file in which a content of the operation of the robot corresponding to the function in the program file is described.

3. The simulation device of claim 1, further comprising a personal computer including a processor, wherein
the processor, by being driven based on a program for performing the simulation, is configured to function as the simulation executing unit, the operation information acquisition unit, and the auxiliary file generating unit.

4. A control system, comprising:
the simulation device of claim 1; and
the programmable logic controller, wherein
the programmable logic controller includes a program generating unit configured to generate a program for driving the programmable logic controller, based on the plurality of auxiliary files.
